(19) United States
(12) Patent Application Publication
(10) Pub. No.: US 2026/0221861 A1
(43) Pub. Date: Jul. 30, 2026

(54) POWER CONVERTER FEEDBACK TRANSITION HANDLING BETWEEN DISCONTINUOUS CONDUCTION MODE (DCM) AND CONTINOUS CONDUCTION MODE (CCM)

(71) Applicant: CIRRUS LOGIC INTERNATIONAL SEMICONDUCTOR LTD., Edinburgh (GB)

(72) Inventors: Vivek Parasuram, Tempe, AZ (US); Ambreesh Bhattad, Fountain Hills, AZ (US)

(21) Appl. No.: 19/040,251

(22) Filed: Jan. 29, 2025

(51) Int. Cl. H02M 1/00; H02M 3/156

(52) U.S. Cl. CPC H02M 1/0048; H02M 3/156

(57) ABSTRACT

A power converter that is selectively operable in PFM or PWM mode provides mode transitions with reduced disruptions. The power converter includes a reference generating block that generates a reference voltage, a first feedback subsystem operational in DCM to provide low quiescent power operation, and a second feedback subsystem operational in CCM to provide high load current. The first feedback subsystem and second feedback systems receive the reference voltage and generate feedback. A transition handling subsystem that is selectively enabled or disabled in response to a control input is included in the power converter, along with a controller that generates the control input. The controller asserts the control input to activate the transition handling system during transitions between PFM and PWM modes, so that the transition handling subsystem prevents disruption of the reference voltage or an output of the power converter.

### FIELD OF THE DISCLOSURE

The field of representative embodiments of this disclosure relates to power conversion circuits, and in particular, to a power converter and control method that reduce disruption when transitioning between discontinuous conduction mode (DCM) and continuous conduction mode (CCM).

### BACKGROUND

Switched-power conversion circuits are commonly used in power supplies and amplification systems due to high power efficiency and reduced magnetic component weight and size. By switching current at a frequency greater than the frequencies to be reproduced by an amplifier, or by switching energy generally, in the case of switching power supplies, the size of magnetic components is reduced and losses required by linear circuit operation are eliminated.

In order to provide efficiency under different conditions in which high output current is required and quiescent conditions in which very low output current is required, mode switching in switching power converters has been applied. In particular, switching between a discontinuous conduction mode (DCM), in which only enough current is injected into the resonant output filter of the power supply to maintain the output voltage and to satisfy any quiescent current requirement, and a continuous conduction mode (CCM), in which the power converter is continuously switched, have long been implemented. However, switching between DCM and PWM operating modes is a process that typically requires careful management and incurs substantial delay to prevent disruption of the operation of the power converter. The latency of such a mode switch becomes critical when high efficiencies are required for overall operation, since, in order to obtain the greatest efficiencies, the power converter must be able to enter and exit DCM rapidly. Low latency operation is needed to obtain the greatest use of DCM when the output current requirements change dramatically, rather than wasting power continuing operation at a minimum pulse width.

Under typical closed-loop operation, the change of the feedback path from a DCM feedback subsystem to a CCM feedback subsystem typically introduces significant latency waiting for the feedback change to settle, which may consume a significant portion of, or all of, intervals in which DCM may be advantageously selected. Alternatively, production of an output transient may be tolerated by eliminating the wait delay, but the output voltage/current transients may exceed specified limits.

Therefore, it would be advantageous to provide a power converter circuit with reduced disruption when transitioning between DCM and CCM operation.

### SUMMARY

A power converter that has reduced disruption when transitioning between DCM and CCMs is provided in a power converter system and its method of operation.

The power converter is a power converter that is selectively operable in DCM or CCM and includes a reference generating block that generates a reference voltage, a first feedback subsystem operational in DCM to provide low quiescent power operation, and a second feedback subsystem operational in CCM to provide high load current. The first feedback subsystem has a first input coupled to an output of the reference generating block to receive the reference voltage and the second feedback subsystem has a second input coupled to the output of the reference generating block to receive the reference voltage. The power converter also includes a transition handling subsystem that is selectively enabled or disabled in response to a control input, and a controller that has an output coupled to the control input of the transition handling subsystem to provide the control input. The controller asserts the control input to activate the transition handling system during transitions between DCM and CCM, so that the transition handling subsystem prevents disruption of the reference voltage or an output of the power converter

The summary above is provided for brief explanation and does not restrict the scope of the claims. The description below sets forth example embodiments according to this disclosure. Further embodiments and implementations will be apparent to those having ordinary skill in the art. Persons having ordinary skill in the art will recognize that various equivalent techniques may be applied in lieu of, or in conjunction with, the embodiments discussed below, and all such equivalents are encompassed by the present disclosure.

### BRIEF DESCRIPTION OF THE DRAWINGS

FIG. 1 is a block diagram illustrating an example power management integrated circuit (PMIC) 10, in accordance with an embodiment of the disclosure.

FIG. 2 is a block diagram illustrating details of example switch-mode power supply (SMPS) control block 20 within PMIC 10 of FIG. 1, in accordance with an embodiment of the disclosure.

FIG. 3 is a simplified schematic diagram illustrating details of example feedback/modulation block 30 in example switch-mode power supply (SMPS) control circuit 20 of FIG. 2, in accordance with an embodiment of the disclosure.

FIG. 4 is an example signal waveform diagram 40, illustrating example signal waveforms within example PMIC 10 of FIG. 1, in accordance with an embodiment of the disclosure.

FIG. 5 is a simplified schematic diagram illustrating an example circuit 50, that may be included within example PMIC 10 of FIG. 1, in accordance with an embodiment of the disclosure.

FIG. 6 is a simplified schematic diagram illustrating an example circuit 61A, in accordance with an embodiment of the disclosure.

FIG. 7 is a flowchart 70 illustrating example operation of control circuits within example PMIC 10 of FIG. 1, in accordance with an embodiment of the disclosure.

FIG. 8 is a simplified schematic diagram illustrating an example circuit 61B, in accordance with another embodiment of the disclosure.

FIG. 9 is a flowchart 90 illustrating example operation of control circuits within example PMIC 10 of FIG. 1, in accordance with another embodiment of the disclosure.

FIGS. 10A-10C are simplified schematic diagrams illustrating example circuit 110A-110C, respectively, that may be used to implement transition handling subsystem 60 of FIG. 5, in accordance with various embodiments of the disclosure.

FIG. 11 is a simplified schematic diagram illustrating an example circuit 120 that may be used to implement transition handling subsystem 60 of FIG. 5, in accordance with another embodiment of the disclosure.

### DETAILED DESCRIPTION

The present disclosure encompasses systems, circuits and integrated circuits that implement power converters that are selectively operable in discontinuous conduction mode (DCM) or continuous conduction mode (CCM) and provide mode transitions with reduced disruptions. The power converter includes a reference generating block that generates a reference voltage, a first feedback subsystem operational in DCM to provide low quiescent power operation, and a second feedback subsystem operational in CCM to provide high load current. The first feedback subsystem and second feedback systems receive the reference voltage and generate feedback. A transition handling subsystem that is selectively enabled or disabled in response to a control input is included in the power converter, along with a controller that generates the control input. The controller asserts the control input to activate the transition handling system during transitions between DCM and CCM, so that the transition handling subsystem prevents disruption of the reference voltage or an output of the power converter.

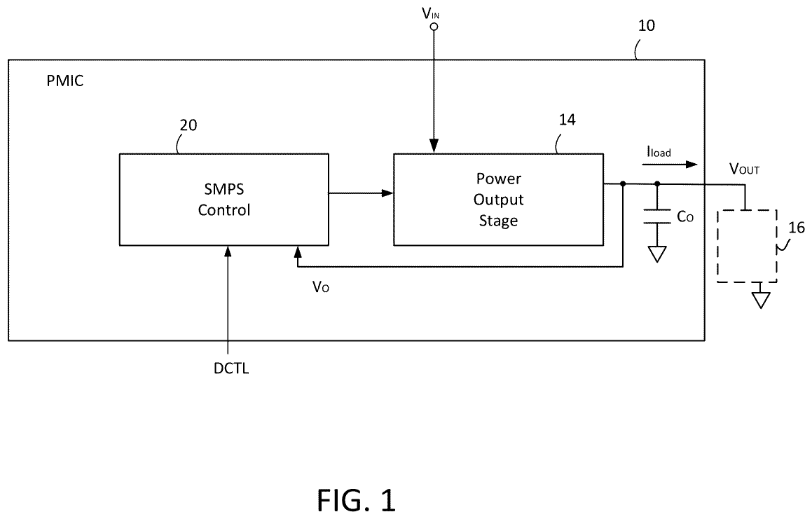

Referring now to FIG. 1, a block diagram of an example power management integrated circuit (PMIC) 10 is shown, in accordance with an embodiment of the disclosure. A switched-mode power supply (SMPS) control block 20 provides switching control signals to a power output stage 14 that generates a power output according to an implemented switching topology. Power output stage 14 is coupled to an output capacitor C_{O} that filters the output of power output stage 14, which is provided to a system 16 being power-managed by PMIC. A voltage feedback loop, which alternatively may be a current feedback loop when an output current I_{load} is controlled, rather than an output voltage V_{O}, supplies a feedback signal to SMPS control block 20 to control the switching control signals provided to power output stage 14. Power output stage 14 receives energy from a power source, which in the example embodiment is an input voltage V_{IN}, which may be, for example, a battery, a rectified and filtered AC power source, or other suitable power supply. SMPS control block 20, in accordance with embodiments described in further detail below, provides multiple operating modes, in order to provide efficiency at both low and high levels of output current I_{load}. In particular, SMPS control block 20 may operate power output stage 14 selectively in CCM or DCM. Further, portion of SMPS control block 20 may be selectively enabled and disabled, based on the selected operating mode to, for example, reduce quiescent power consumption when operating in DCM. While the above description and various embodiments illustrated herein are directed to a switched-mode power supply (SMPS), it is understood that the techniques disclosed herein may be used in other power conversion systems, such as Class-D amplifiers.

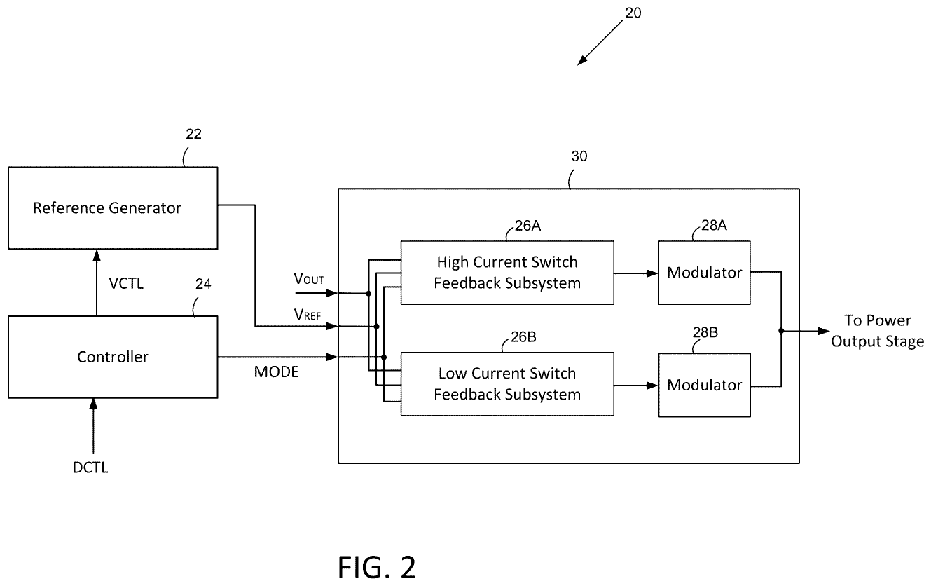

Referring now to FIG. 2, a block diagram illustrating details of example switch-mode power supply (SMPS) control block 20 in PMIC 10 of FIG. 1, is shown in accordance with an embodiment of the disclosure. A reference generator 22 provides a reference voltage V_{REF}

to a feedback/modulation block 30 that generates output signals provided to power output stage 14 in PMIC 10 of FIG. 1. A controller 24 controls the operating mode of PMIC 10 of FIG. 1 according to a control signal/value MODE, which may be derived from a digital control input DCTL, but that may alternatively, or in combination, be determined by controller 24 from various inputs, such as measurements of output current I_{LOAD} as output current I_{LOAD} varies over time. Controller 24 may also provide a control value VCTL that is provided to reference generator 22 to set the value of reference voltage V_{REF}. Feedback/modulation block 30 receives reference voltage V_{REF} as well as feedback via output voltage V_{OUT}, which are provided to two different feedback/modulation subsystems 26A, 26B. Feedback subsystem 26A is a high current switch feedback subsystem that provides input to a first modulator 28A, and is generally selected for efficiency when higher (operational) output currents are required from PMIC 10 of FIG. 1. Feedback subsystem 26B is a low current switch feedback subsystem that provides input to a second modulator 28B, and is generally selected for efficiency when lower, quiescent, output currents are required from PMIC 10 of FIG. 1 to maintain output voltage V_{OUT} at a required voltage level, e.g., when system 16 is in a low-power mode such as sleep or standby modes. When DCM is selected, various blocks within feedback/modulation block 30 may be disabled, and are re-enabled when entering CCM, which may cause disruption of reference voltage V_{REF}, as will be described in further detail below.

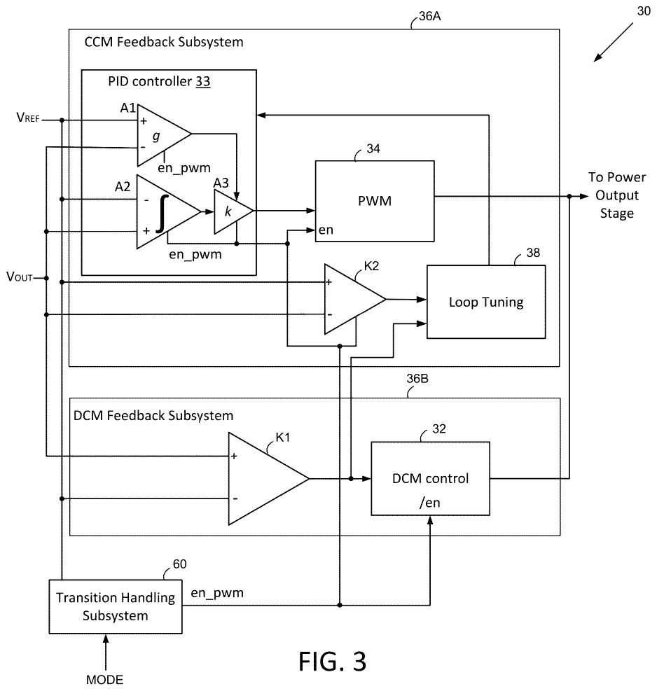

Referring now to FIG. 3, a simplified schematic diagram illustrating details of example feedback/modulation block 30 of FIG. 2, is shown in accordance with an embodiment of the disclosure. Example switch-mode power supply (SMPS) control circuit 30 includes a CCM feedback subsystem 36A and a DCM feedback subsystem 36B that generate outputs provided to power output stage 14 in PMIC 10 of FIG. 1. DCM feedback subsystem 36B includes a comparator K1 that determines when output voltage V_{OUT} has fallen below reference voltage V_{REF} and signals a DCM control circuit 32 to generate one or more output pulses from power output stage 14 in PMIC 10 of FIG. 1, when DCM feedback subsystem 36B is active, to restore output voltage V_{OUT}. CCM feedback subsystem 36A includes a proportional-integral-derivative (PID) controller 33 that includes an integrator A2 that integrates error between output voltage V_{OUT} and reference voltage V_{REF}, and the result is scaled by a scaling factor k by a scaling amplifier A3. Scaling factor k is dynamically adjusted by a proportional gain amplifier A1 that also operates on the error between output voltage V_{OUT} and reference voltage V_{REF}. The output of scaling amplifier A3 is provided to a pulse-width modulator (PWM) 34 that generates a pulse-width modulated signal provided to power output stage 14 in PMIC 10 of FIG. 1 when CCM feedback system 36A is active. CCM feedback subsystem 36A also includes an overshoot comparator K2 that signals a loop tuning block 38 to adjust the response of PID controller 33 when voltage overshoot is occurring in output voltage V_{OUT}, e.g., overshoot comparator K2 may be triggered when output voltage V_{OUT} exceeds reference voltage V_{REF} by a predetermined percentage. Loop tuning block 38 may also receive the output of comparator K1 in DCM feedback subsystem 36B, and therefore comparator K1 may thereby be shared by CCM feedback subsystem 36A.

Control of which of CCM feedback subsystem 36A and a DCM feedback subsystem 36B is active is determined by control signal/value MODE, which, in the illustrated example, is processed by a transition handling subsystem 60 to generate a control signal en_pwm, which enables various blocks within CCM feedback subsystem 36A and disables at least the output of DCM control 32 within DCM feedback subsystem 36B. In the illustrated example, PWM 34, integrator A2, proportional-gain amplifier A1, scaling amplifier A3, and overshoot comparator K2 are enabled by control signal en_pwm, which reduces power consumption of PMIC 10, when high/non-quiescent output current I_{LOAD} is required by system 16 in FIG. 1. When transition handling subsystem 60 activates CCM feedback subsystem 36A, the activation of the analog circuit blocks connected to reference voltage V_{REF} disrupts the output of reference generator 22 of FIG. 2, which causes error in output voltage V_{OUT} of PMIC 10. In order to counteract or avoid the disruption, or in some embodiments to prevent the disruption, transition handling subsystem 60 may be coupled to reference voltage V_{REF}, i.e., to the output of reference generator 22 of FIG. 2.

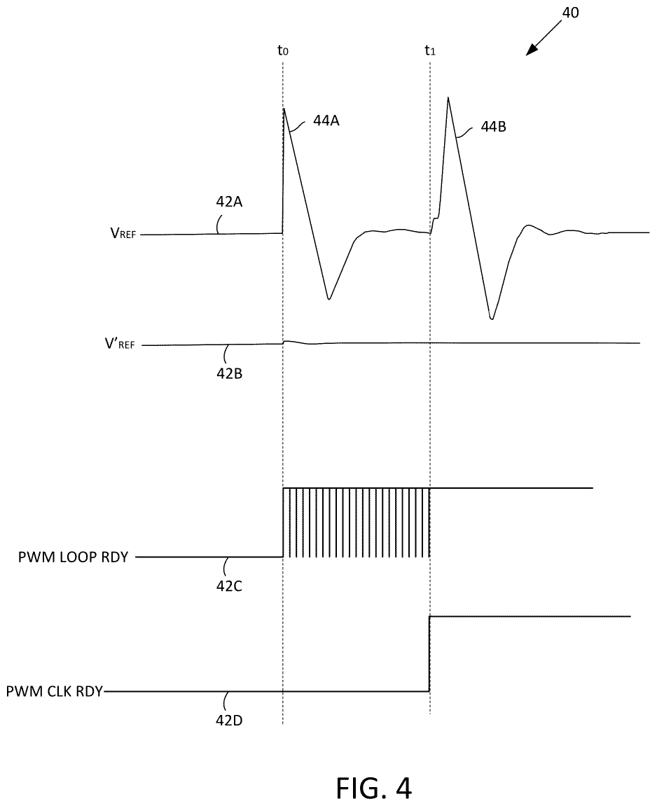

Referring now to FIG. 4, an example signal waveform diagram 40, illustrating example signal waveforms within example PMIC 10 of FIG. 1, is shown in accordance with an embodiment of the disclosure. Signal CCM LOOP RDY 42C is a control signal that prepares for a change to CCM and PWM CLK RDY 42D is a signal that enables the PWM 34 within example feedback/modulation block 30 of FIG. 3. The first time the analog circuits within CCM feedback subsystem 36A are enabled at a time t₀, a transient 44A occurs on reference voltage V_{REF}, and another transient 44B occurs when PWM CLK RDY 42D enables the remainder of the circuits within CCM feedback subsystem 36A at a time t₁. In accordance with various embodiments below that counteract transients 44A, 44B, a resultant value V′_{REF} is produced, reducing the impact of enabling PWM feedback subsystem 36A. In accordance with other embodiments described below, operation of PWM 34 may be delayed until the effects of transients 44A, 44B have passed or have been avoided.

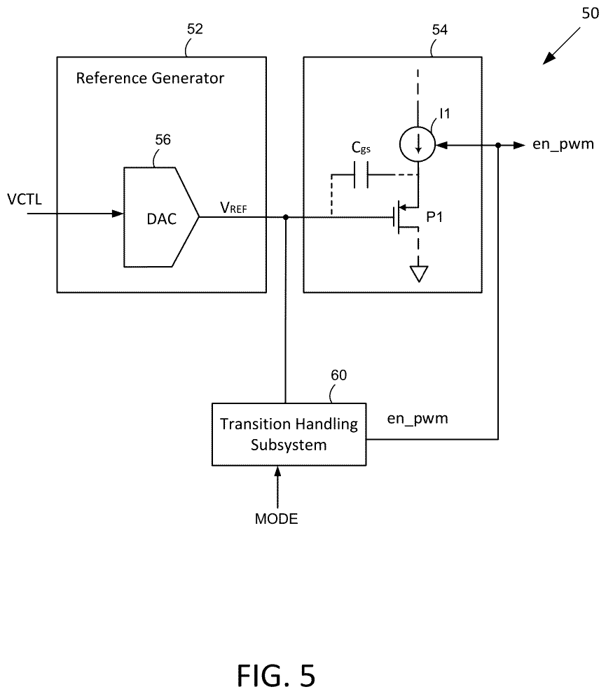

Referring now to FIG. 5, a simplified schematic diagram illustrating an example circuit that may be included within example PMIC 10 of FIG. 1, is shown, in accordance with an embodiment of the disclosure. A reference generator 52 includes a digital-to-analog converter (DAC) 56 that generates reference voltage V_{REF} according to control value VCTL. A circuit 54 is representative of one of the analog input circuits of PWM feedback subsystem 36A, showing an input node provided by a gate of a transistor P1 that directs current from a current source I1 to introduce reference voltage V_{REF} to the remainder of example circuit 54. When circuit 54 is activated as control signal en_pwm is asserted, current source I1 is activated and the gate-source capacitance Cgs causes a transient to occur on reference voltage V_{REF}, momentarily disrupting the output of DAC 56. Transition handling subsystem 60 either counteracts or avoids the transient on reference voltage V_{REF}, preventing or avoiding the transient.

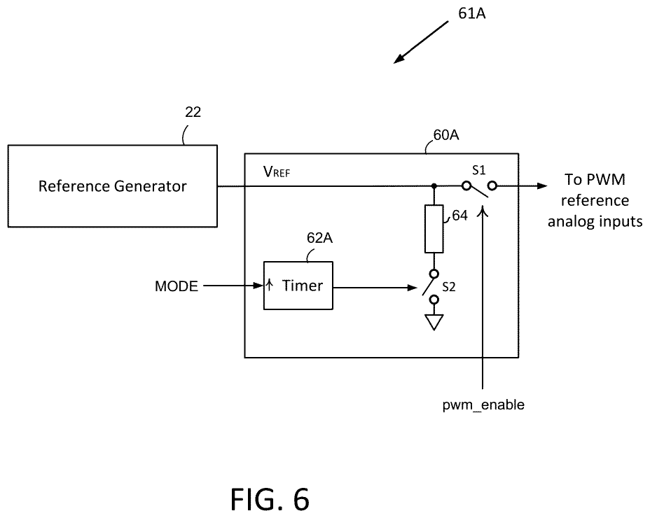

Referring now to FIG. 6, a simplified schematic diagram illustrating an example circuit 61A is shown, in accordance with an embodiment of the disclosure. Example circuit 61A illustrates the connection of reference generator 22 with a transient handling subsystem 60A, that avoids the above-described transient on reference voltage V_{REF} by connecting the output of reference generator 22 to a low impedance load 64 temporarily, for a predetermined time after control signal MODE is asserted via a timer 62A which activates a switch S2 to couple a load 64, which may be a resistance, a capacitance, or a combination of both, to the output of reference generator 22, so that the transient on reference voltage V_{REF} is dissipated before a switch S1 is closed, under control of control signal MODE to connect reference voltage V_{REF} to the analog inputs of CCM feedback subsystem 36A of FIG. 3.

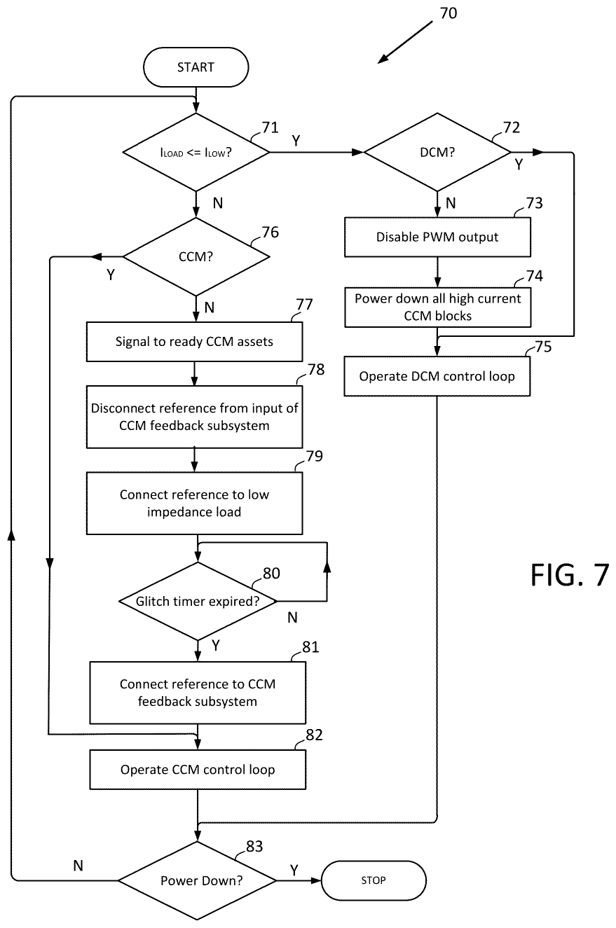

Referring now to FIG. 7, a flowchart 70 illustrating example operation of control circuits within example PMIC 10 of FIG. 1, is shown in accordance with an embodiment of the disclosure. Flowchart 70 illustrates a process that may be used to control example circuit 61A of FIG. 6, in accordance with an embodiment of the disclosure. While output current I_{LOAD} is less than or equal to a threshold current value I_{LOW} (decision 71), if DCM is not yet active (decision 72), the PWM output is disabled (step 73) and all of the high-current CCM blocks are disabled (step 74). The DCM control loop is then operated (step 75) until the system is powered down (step 83) or output current I_{LOAD} exceeds threshold current value I_{LOW} (decision 71). If output current I_{LOAD} exceeds threshold current value I_{LOW} (decision 71), if CCM is active (decision 76), the CCM control loop continues to operate (step 82). If CCM is not yet active (decision 76), control signals are generated to ready the CCM assets (step 77), reference generator 22 is disconnected from the inputs of CCM feedback subsystem 36A (step 78) and the output of reference generator 22 is connected to a low-impedance load (step 79). After a glitch timer has expired (decision 80), reference generator 22 is connected to CCM feedback subsystem 36A (step 81) and the CCM control loop is operated (step 82) until the system is powered down (decision 83) or output current I_{LOAD} falls below threshold current value I_{LOW} (decision 81).

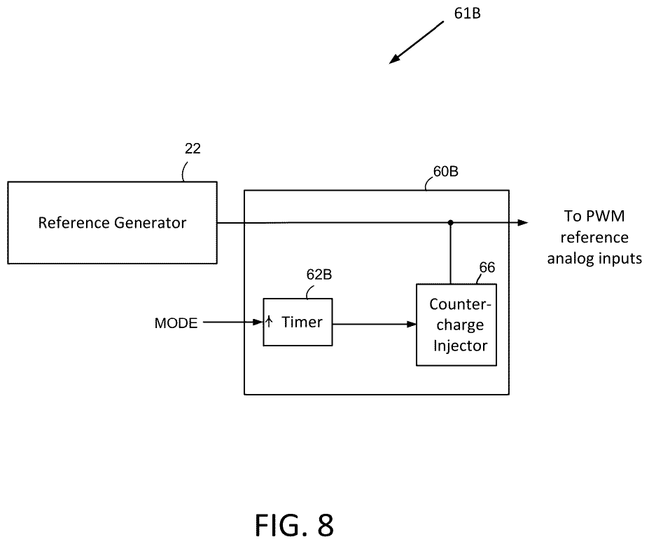

FIG. 8 is a simplified schematic diagram illustrating an example circuit 61B in accordance with another embodiment of the disclosure. Example circuit 61B illustrates the connection of reference generator 22 with a transient handling subsystem 60B, that counteracts the above-described transient on reference voltage V_{REF} by activating a counter-charge injector circuit 66 temporarily, for a predetermined time after control signal MODE is asserted via a timer 62B, to the output of reference generator 22, so that the transient on reference voltage V_{REF} is counteracted by injecting a pulse of opposite polarity and equal energy to the transient.

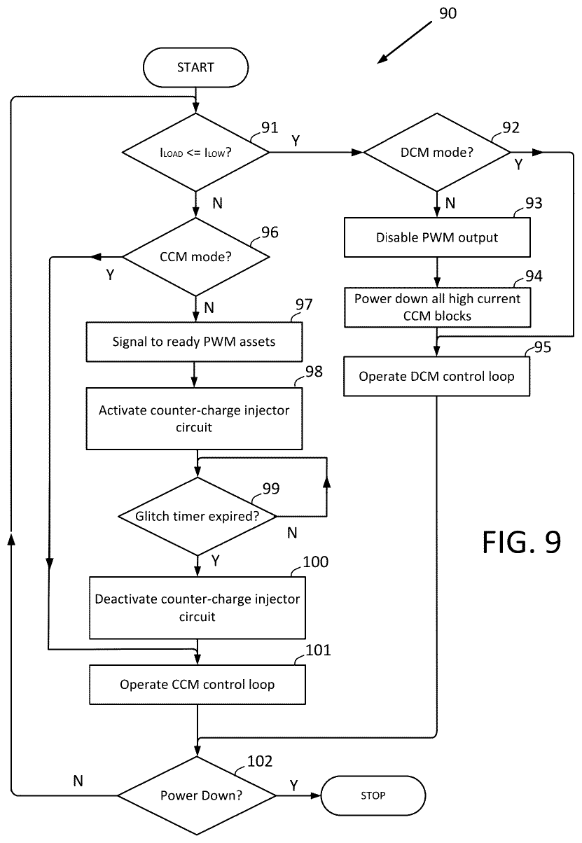

Referring now to FIG. 9, a flowchart 90 illustrating example operation of control circuits within example PMIC 10 of FIG. 1, is shown in accordance with another embodiment of the disclosure. Flowchart 90 illustrates a process that may be used to control example circuit 61A of FIG. 6, in accordance with an embodiment of the disclosure. While output current I_{LOAD} is less than or equal to a threshold current value I_{LOW} (decision 91), if DCM is not yet active (decision 92), the PWM output is disabled (step 93) and all of the high-current CCM blocks are disabled (step 94). The DCM control loop is then operated (step 95) until the system is powered down (step 102) or output current I_{LOAD} exceeds threshold current value I_{LOW} (decision 91). If output current I_{LOAD} exceeds threshold current value I_{LOW} (decision 91), if CCM is active (decision 96), the CCM control loop continues to operate (step 101). If CCM is not yet active (decision 96), control signals are generated to ready the CCM assets (step 97), and a counter-charge injector circuit is activated (step 98) to inject charge to counteract the transient charge injected by the CCM assets when they are enabled. After a glitch timer has expired (decision 99), the counter-charge injection circuit is de-activated (step 100) and the CCM control loop is operated (step 101) until the system is powered down (decision 102) or output current I_{LOAD} falls below threshold current value I_{LOW} (decision 91).

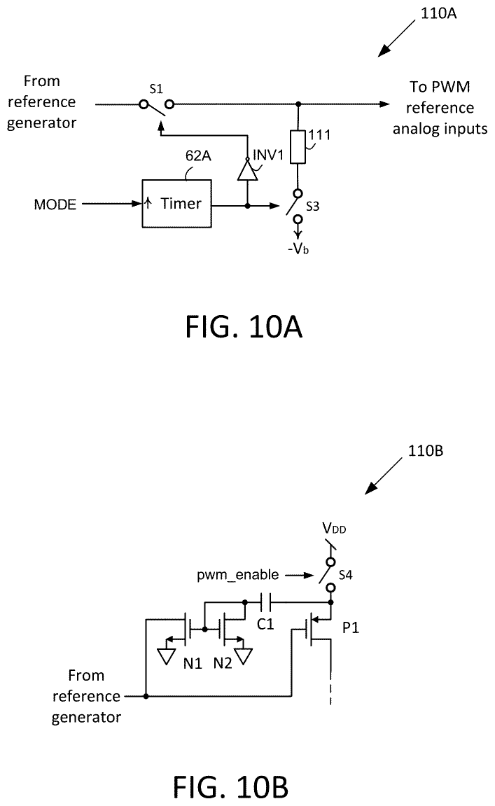

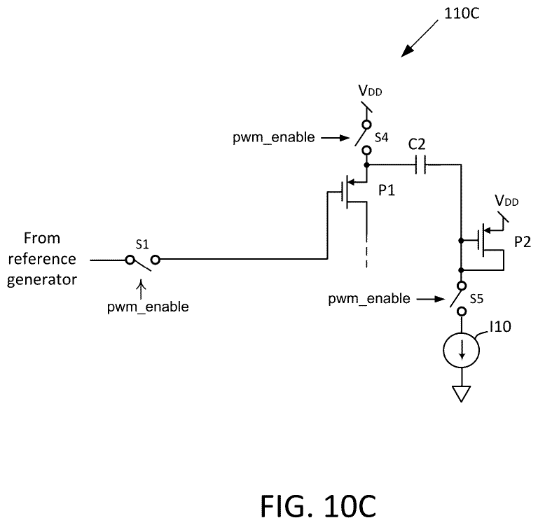

FIGS. 10A-10C are simplified schematic diagrams illustrating example circuit 110A-110C, respectively, that may be used to implement transition handling subsystem 60 of FIG. 5, in accordance with various embodiments of the disclosure. Circuit 110A is an example of a circuit performing counter-charge injection as illustrated in circuit 61B of FIG. 8. When timer 62B is activated by assertion of control signal MODE, switch S1 is opened via an inverter INV1 to disconnect the output of reference generator 22 from the analog inputs of CCM feedback subsystem 36A of FIG. 3 and a switch S3 is closed to connect a charge injecting component 111, which is generally a capacitance, but which may be a resistance, depending on the available node capacitance to inject a negative transient of substantially equal energy to the positive transient generated on reference voltage V_{REF} when CCM is selected by assertion of control signal MODE. Switch S3 couples a first terminal of charge injecting component 111 to a negative bias voltage-Vb and the second terminal of charge injecting component 111 is connected to the output of reference generator 22. FIG. 10B shows another mechanism for injecting a counter-charge transient that does not require a timer. When control signal pwm_enable is asserted to energize an input stage of CCM feedback subsystem 36A of FIG. 3 as illustrated by a transistor P1 by activating a switch S4 to couple transistor P1 to positive power supply rail V_{DD}, a transistor N2 that has a gate and source coupled to the source of transistor P1 via a capacitor C1, turns on briefly, along with a transistor N1, which clamps the output of reference generator 22 during the interval that transistors N1 and N2 are active. Transistors N1, N2, and capacitor C1 may be sized and optionally trimmed, to produce the required counter-transient. FIG. 10C shows another mechanism for injecting a counter-charge transient. When control signal pwm_enable is asserted to energize an input stage of CCM feedback subsystem 36A of FIG. 3 as illustrated by transistor P1 by activating switch S4, a current source I10 is coupled by a switch S5 and a diode-connected transistor P2 through a capacitor C2 sized to produce the required counter-transient to prevent the positive transient that would otherwise be coupled through the drain-gate capacitance of transistor P1.

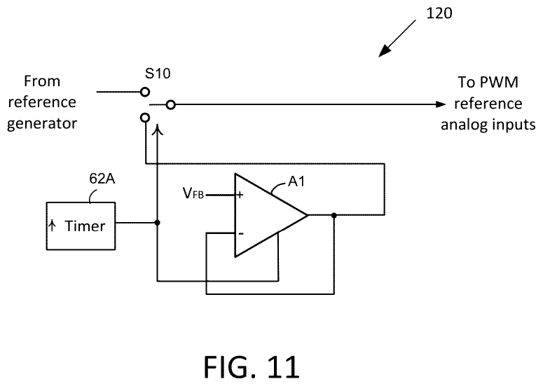

Referring now to FIG. 11, a simplified schematic diagram illustrating an example circuit 120 that may be used to implement transition handling subsystem 60 of FIG. 5, in accordance with another embodiment of the disclosure. Circuit 120 is an example of a circuit performing low-impedance loading and dissipation of the transient on reference voltage as illustrated in circuit 61A of FIG. 6. Rather than using a resistance or capacitance coupled to the output of reference generator 22, circuit 120 includes an amplifier A1 that provides a low-impedance output loading the output of reference generator 22 while connected via a switch S10 that isolates reference generator 22 from the analog input(s) of CCM feedback subsystem 36A of FIG. 3 when timer 62A is active. Amplifier A1 may be biased by the output of timer 62A, or alternatively by the invert of control signal MODE, so that energy consumed by amplifier A1 is reduced to a negligible level during DCM operation.

In summary, this disclosure shows and describes techniques and circuits for power conversion and power converter circuits. The power converters may selectively operable in DCM and CCM, and may include a reference generating block that generates a reference voltage, a first feedback subsystem operational in DCM to provide low quiescent power operation, wherein the first feedback subsystem may have a first input coupled to an output of the reference generating block to receive the reference voltage, and a second feedback subsystem operational in CCM to provide high load current, wherein the second feedback subsystem has a second input coupled to the output of the reference generating block to receive the reference voltage. The power converters may also include a transition handling subsystem that is selectively enabled or disabled in response to a control input, and a controller having an output coupled to the control input of the transition handling subsystem to provide the control input. The controller may assert the control input to activate the transition handling system during transitions between DCM and CCM, so that the transition handling subsystem prevents disruption of the reference voltage or an output of the power converter.

In some example embodiments, the first feedback subsystem may be a comparator-based feedback subsystem. In some example embodiments, the second feedback subsystem may be an amplifier-based feedback subsystem. In some example embodiments, the transition handling subsystem may include a voltage amplifier that is selectively enabled or disabled according to the control input. In some example embodiments, the controller may vary a bias supplied to the voltage amplifier.

In some example embodiments, the transition handling subsystem may include a current-based charge injection circuit that injects a compensating opposite charge to counteract charge injected at the output of the reference generating block due to the transitions between DCM and CCM. In some example embodiments, the current-based charge injection circuit may include a capacitor coupled between the output of the reference generating block and a switching circuit that selectively couples the capacitor to a voltage reference to generate the compensating opposite charge when the switching circuit is activated during the transitions. In some example embodiments, the current-based charge injection circuit may include a resistor coupled between the output of the reference generating block and a switching circuit that selectively couples the resistor to a voltage reference to generate the compensating opposite charge by charging a capacitance of the output of the reference generating block when the switching circuit is activated during the transitions.

In some example embodiments, the transition handling subsystem may include a timed control system that selectively disconnects the output of the reference voltage generating circuit from the second input and connects the second input to a low impedance node during the transitions between DCM and CCM. In some example embodiments, the controller may selectively disable at least a portion of the second feedback subsystem in DCM, and the transition handling subsystem may prevent disruption of the reference voltage due to charge injection at the output of the reference-generating block that occurs when the controller enables the portion of the second feedback subsystem during a transition to CCM.

In some example embodiments, the reference generating block may include a digital-to-analog converter (DAC), the output of the reference generating block may be provided by an output of the digital-to-analog converter, and the charge injection may occur from one or more blocks of the amplifier-based feedback subsystem. In some example embodiments the one or more blocks of the second feedback subsystem may include one or more of an integrator, a proportional gain block, an output voltage comparator, and a voltage overshoot comparator.

While the disclosure has shown and described particular embodiments of the techniques disclosed herein, it will be understood by those skilled in the art that the foregoing and other changes in form, and details may be made therein without departing from the spirit and scope of the disclosure. For example, the techniques shown above may be applied to another type of power conversion system having different types of selectable modulation modes.

What is claimed is:

1. A power converter selectively operable in a discontinuous conduction mode (DCM) and a continuous conduction mode (CCM), the power converter circuit comprising:
a reference generating block that generates a reference voltage;
a first feedback subsystem operational in DCM to provide low quiescent power operation, wherein the first feedback subsystem has a first input coupled to an output of the reference generating block to receive the reference voltage;
a second feedback subsystem operational in CCM to provide high load current, wherein the second feedback subsystem has a second input coupled to the output of the reference generating block to receive the reference voltage;
a transition handling subsystem that is selectively enabled or disabled in response to a control input; and
a controller having an output coupled to the control input of the transition handling subsystem to provide the control input, wherein the controller asserts the control input to activate the transition handling system during transitions between DCM and CCM, whereby the transition handling subsystem prevents disruption of the reference voltage or an output of the power converter.

2. The power converter of claim 1, wherein the first feedback subsystem is a comparator-based feedback subsystem.

3. The power converter of claim 1, wherein the second feedback subsystem is an amplifier-based feedback subsystem.

4. The power converter of claim 1, wherein the transition handling subsystem comprises a voltage amplifier that is selectively enabled or disabled according to the control input.

5. The power converter of claim 4, wherein the controller varies a bias supplied to the voltage amplifier.

6. The power converter of claim 1, wherein the transition handling subsystem comprises a current-based charge injection circuit that injects a compensating opposite charge to counteract charge injected at the output of the reference generating block due to the transitions between DCM and CCM.

7. The power converter of claim 6, wherein the current-based charge injection circuit comprises a capacitor coupled between the output of the reference generating block and a switching circuit that selectively couples the capacitor to a voltage reference to generate the compensating opposite charge when the switching circuit is activated during the transitions.

8. The power converter of claim 6, wherein the current-based charge injection circuit comprises a resistor coupled between the output of the reference generating block and a switching circuit that selectively couples the resistor to a voltage reference to generate the compensating opposite charge by charging a capacitance of the output of the reference generating block when the switching circuit is activated during the transitions.

9. The power converter of claim 1, wherein the transition handling subsystem comprises a timed control system that selectively disconnects the output of the reference voltage generating circuit from the second input and connects the second input to a low impedance node during the transitions between DCM and CCM.

10. The power converter of claim 1, wherein the controller selectively disables at least a portion of the second feedback subsystem in DCM, wherein the transition handling subsystem prevents disruption of the reference voltage due to charge injection at the output of the reference-generating block that occurs when the controller enables the portion of the second feedback subsystem during a transition to CCM.

11. The power converter of claim 10, wherein the reference generating block comprises a digital-to-analog converter (DAC), wherein the output of the reference generating block is provided by an output of the digital-to-analog converter, and wherein the charge injection occurs from one or more blocks of the amplifier-based feedback subsystem.

12. The power converter of claim 11, wherein the one or more blocks of the second feedback subsystem include one or more of an integrator, a proportional gain block, an output voltage comparator and a voltage overshoot comparator.

13. A method of operating a power converter selectively in a discontinuous conduction mode (DCM) and a continuous conduction mode (CCM), the method comprising:
generating a reference voltage at an output of a reference generating block;
providing first feedback in DCM to provide low quiescent power operation, wherein the first feedback is generated by a first feedback subsystem that generates the first feedback from the reference voltage;
providing second feedback in CCM to provide high load current wherein the second feedback is generated by a second feedback subsystem that generates the second feedback from the reference voltage;
selectively enabling a transition handling subsystem in response to a control input; and
asserting the control input to activate the transition handling system during transitions between DCM and CCM, whereby the transition handling subsystem prevents disruption of the reference voltage or an output of the power converter.

14. The method of claim 13, wherein the first feedback subsystem is a comparator-based feedback subsystem.

15. The method of claim 13, wherein the second feedback subsystem is an amplifier-based feedback subsystem.

16. The method of claim 13, wherein the selectively enabling the transition handling subsystem comprises selectively enabling a voltage amplifier according to the control input.

17. The method of claim 16, further comprising varying a bias supplied to the voltage amplifier.

18. The method of claim 13, further comprising injecting a compensating opposite charge to counteract charge injected at the output of the reference generating block due to the transitions between DCM and CCM.

19. The method of claim 18, wherein the injecting comprises transferring charge with a capacitor coupled to the output of the reference generating block by selectively coupling the capacitor to a voltage reference to generate the compensating opposite charge during the transitions.

20. The method of claim 18, wherein the injecting comprises charging a capacitance of the output of the reference generating block with a resistor coupled to the output of the reference generating block by selectively coupling the resistor to a voltage reference to generate the compensating opposite charge during the transitions.

21. The method of claim 13, further comprising according to a timed control system, selectively removing the reference voltage from an input of the second feedback subsystem and connecting the input of the second feedback subsystem to a low impedance node during the transitions between DCM and CCM.

22. The method of claim 13, further comprising disabling at least a portion of the second feedback subsystem in DCM, wherein the selectively enabling the transition handling subsystem prevents disruption of the reference voltage due to charge injection at the output of the reference-generating block that occurs when the portion of the second feedback subsystem is enabled during a transition to CCM.

23. The method of claim 22, wherein the reference generating block includes a digital-to-analog converter (DAC), wherein the output of the reference generating block is provided by an output of the digital-to-analog converter, and wherein the charge injection occurs from one or more blocks of the second feedback subsystem.

24. The method of claim 23, wherein the one or more blocks of the second feedback subsystem include one or more of an integrator, a proportional gain block, an output voltage comparator and a voltage overshoot comparator.
